(19) United States
(12) Patent Application Publication
(10) Pub. No.: US 2012/0290906 A1
(43) Pub. Date: Nov. 15, 2012

(54) E Book Method

(76) Inventor: Daniel Austin Robey, Miami, FL (US)

(21) Appl. No.: 13/471,413

(22) Filed: May 14, 2012

Related U.S. Application Data
(60) Provisional application No. 61/485,168, filed on May 12, 2011.

(51) Int. Cl. G06F 17/20

(52) U.S. Cl. 715/202

(57) ABSTRACT

An electronic book dynamically created and updated with demographically targeted audio, video, images and text in response to customer query of interests, location, and other attributes. The present invention generally relates to the creation and publishing of electronic books and more specifically to a method and system for creating multimedia electronic books that have dynamically changeable video and audio content. The present invention also relates to a method and system for creating electronic books that contain demographically targeted dynamically changeable video, audio, image and text content

### FIELD OF THE PRESENT INVENTION

Electronic books have become popular tools for the dissemination of knowledge and are commonly referred to as e-books. An e-book is a computer program displaying pages that mimic a printed book, but also have the ability to display video, images and audio.

### BACKGROUND OF THE PRESENT INVENTION

The present invention provides a method of improving the functionality of e-books by dynamically changing the video, audio, image and text content of a consumer's purchased e-book based on the interests of the consumer. The present invention permits a consumer's purchased electronic book to be dynamically updated by the publisher with demographically targeted audio, video, images and text in response to customer query of interests, location, and other attributes.

The present invention generally relates to the creation and publishing of electronic books and more specifically to a method and system for creating multimedia electronic books that have dynamically changeable video and audio content. The present invention also relates to a method and system for creating electronic books that contain demographically targeted dynamically changeable video, audio, image and text content.

### SUMMARY OF THE INVENTION

An e-book is generally defined as a book published in electronic form. As those skilled in the art understand, an e-book displays contents in the form of text, images, audio and video that have been incorporated into the e-book during the typographical layout and production process. Historically, once a consumer downloaded an e-book to his or her computer, the contents of the e-book remained static and unchangeable by the publisher of the e-book.

The present invention provides a novel and unique method for a book publisher to dynamically change the contents of a book that has already been sold to a consumer. It also provides an e-book publisher with the ability to dynamically change in real time the video, audio, image and text contents of a consumer's e-book based on the queried results of demographic consumer data.

### BRIEF DESCRIPTION OF THE DRAWINGS

FIG. 1 is a block diagram illustrating a system for dynamically controlling the video and audio content of an e-book that has previously been downloaded and stored on a user's computer.

FIG. 2 is a flow diagram illustrating a method for creating a company and e-book profile.

FIG. 3 illustrates what occurs when the system compiles and creates e-book templates from the company database.

### DETAILED DESCRIPTION OF THE PRESENT INVENTION

The present invention provides a novel and unique method for a book publisher to dynamically change the contents of an e-book that has already been sold to a consumer. Dynamic, demographically targeted changes to video, audio, text and image content are made in real time and delivered to a unique copy of the consumer's e-book stored on the consumer's personal computer hard drive or other data storage device for as long as the e-book exists on the consumer's computer. The consumer's e-book content modifications are transparent to the consumer and require no action on the part of the consumer other than simply opening and reading the e-book.

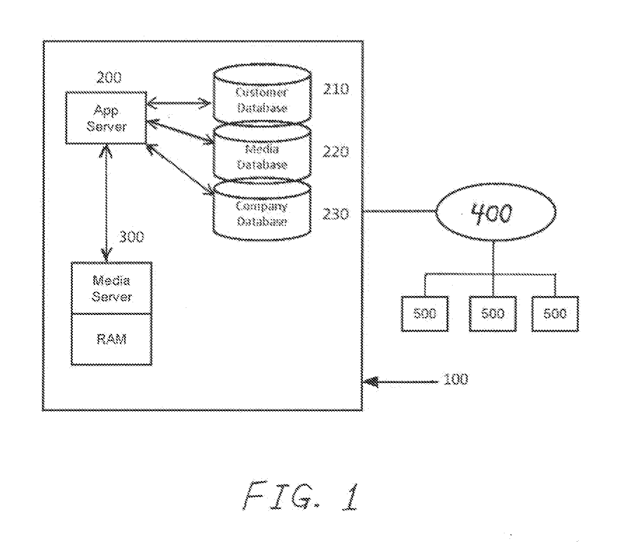

FIG. 1 is a block diagram illustrating a system (100) for dynamically controlling the video and audio content of an e-book that has previously been downloaded and stored on a user's computer (500). This system (100) for creating dynamic, demographically targetable e-books. includes an application server (200) and media server (300). The system (100) is connected by a network (400) (e.g., the internet) to a plurality of computers (500). The application server (200) manages a customer database (210), media database (220), and company database (230).

The customer database (210) contains profile information for each of the customers. The profile information may include a unique customer identifier, name, age, hometown, location, listings of interest, attributes and the like. In addition, the contents of the customer database (210) are indexed and optimized for search.

The media database (220) contains video, audio, images, text files and the like. Each media file contains a profile that may include demographic data, location data, interest data, attribute data, gender data, and the like.

The company database (230) contains a company profile and an e-book profile. The company profile may include product data, demographic data, and the like. The e-book profile contains e-book layout and design data, formatting data, text data, video data, audio data, image data and the like.

The customer database (210), the media database (220) and the company database (230) are updated to reflect new customer information as well as edits of existing customer information transmitted from computers (500) over the network (400). The application server (200) compiles information it receives from the customer database (210), media database (220) and company database (230) and compiles this information into a unique customer e-book.

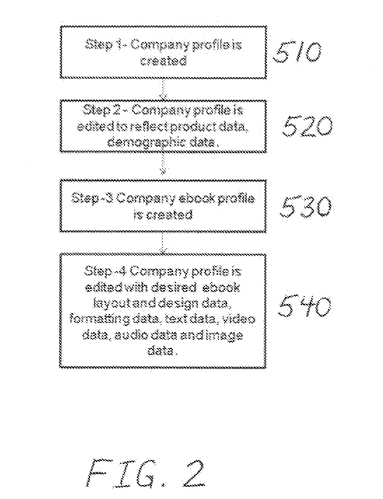

FIG. 2 is a flow diagram illustrating a method for creating a company and e-book profile. In Step 1 (510), a blank company profile is created and stored in the company database. In Step 2 (520), the company profile is edited to include product data and demographic data, and the edited profile is stored in the company database. In Step 3 (530), an e-book profile is created and stored in the company database. In Step 4 (540), the e-book profile is edited to include e-book layout and design data, formatting data, text data, video data, audio data and image data, and the edited profile is then stored in the company database.

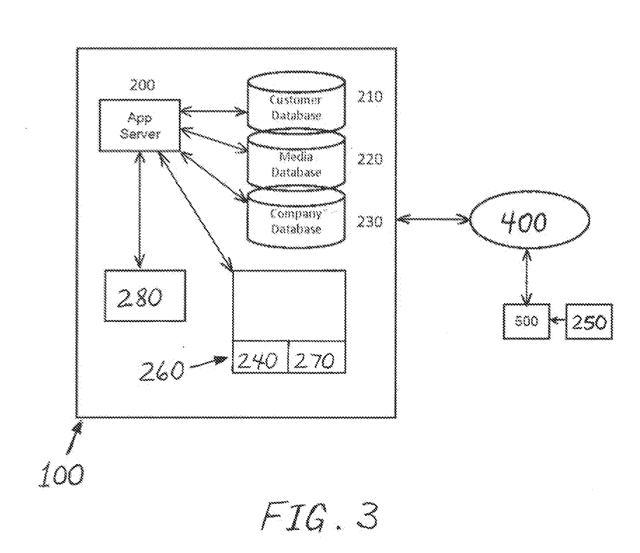

FIG. 3 illustrates what occurs when the system (100) has identified the information it requires to compile and create a master e-book template (260) from the company database (230). The application server (200) compiles the master e-book template (260) and inserts unique placemark data (240) for each content item, e.g., images, text, video and audio. The placemark data (240) contains information on where the content items are located in the media database (220) as well as e-book location data (270).

The master e-book template (260) also contains information gathered from a third party e-book application (250) filled out by the consumer, containing requests for name, age, hometown, location, and listings of interest. The third party e-book application (250) is filled out by the consumer when the company distributes the purchased master e-book template (260) via the internet network (400) to the consumer's computer (500). The consumer information gathered from the third party e-book application (250) is then stored in the customer database (210).

When the application server (200) receives the consumer information from the customer database (210), it compiles and creates a unique e-book (280) with a unique master customer ID and stores the unique e-book (280) on the customer database (210). Specific advertisements or other content of interest to the consumer can now be directed to the customer's unique e-book (280).

I claim:

1. An electronic book dynamically created and updated with demographically targeted audio, video, images and text in response to customer query of interests, location, and other attributes and the creation and publishing of electronic books and more specifically to a method and system for creating multimedia electronic books that have dynamically changeable video and audio content

2. A method and system for creating electronic books that contain demographically targeted dynamically changeable video, audio, image and text content.
